(19) United States
(12) Patent Application Publication
(10) Pub. No.: US 2004/0232113 A1
(43) Pub. Date: Nov. 25, 2004

(54) Electric switching device for medium or high voltage

(76) Inventors: Edelhard Kynast, Deutschland (DE); Jorg Scharschmidt, Berlin (DE); Frank Schmidt, Langenhagen (DE)

Correspondence Address: MORRISON & FOERSTER LLP, 1650 TYSONS BOULEVARD, SUITE 300, MCLEAN, VA, 22102, US

(21) Appl. No.: 10/486,728

(22) PCT Filed: Jul. 29, 2002
(86) PCT No.: PCT/DE02/02853

(30) Foreign Application Priority Data
Aug. 14, 2001 (DE) 101396244

(51) Int. Cl. H01H 33/66

(52) U.S. Cl. 218/136

(57) ABSTRACT

In order to ensure the outer dielectric strength of an interrupter unit, the interrupter unit is arranged inside a housing. The housing is filled with an insulating material. The insulating material is a soft gel, in particular a thixotropic gel.

### CLAIM FOR PRIORITY

This application claims priority to International Application No. PCT/DE02/02853, which was published in the German language on Jul. 29, 2002, which claims the benefit of priority to Germany Application No. DE 101 39 624.4 which was filed in the German language on Aug. 14, 2001.

### TECHNICAL FIELD OF THE INVENTION

The invention relates to an electric switching device for medium or high voltage, and in particular, for the interruption of an electric current path by an interrupter unit, which is arranged inside a housing filled with a gel acting as an insulating material.

### BACKGROUND OF THE INVENTION

An electric switching device is known for example from U.S. Pat. No. 3,471,669. The known switching device has an interrupter unit for interrupting a current path by means of a movable contact piece. For driving the movable contact piece, a drive device is provided. The interrupter unit and the drive device are arranged inside a metal housing. Inside the housing, the interrupter unit and the drive device are positioned by a permanently elastic insulating material. This insulating material is a solid shaped body, through which a drive rod and the electrical connecting pieces are led.

In the case of such an enclosed switching device, servicing of the interrupter unit and of the drive is quite a laborious undertaking. For servicing work, the solid insulating material must be removed in order to gain access to the subassemblies enclosed by it. This gain access to the subassemblies enclosed by it. This involves destroying the solid insulating material. It is then not possible for this elastic insulating material to be used again. On account of the electric field strengths occurring in the medium or high voltage range, production of the elastic insulating material in individual parts and corresponding arrangement of the individual parts around the subassemblies is not possible. The joints produced in the case of a construction of this type would promote the occurrence of undesired partial discharges.

Furthermore, the use of silicone polymers as an encapsulating material for cable harnesses, in particular for outdoor terminations of high-voltage crosslinked polyethylene cables, is described in the article “Trockene Freiluftendverschlüsse mit Stützeigenschaften” [dry outdoor terminations with supporting properties] (Eitle, Kaumanns; Elektrizitätswirtschaft, year 99 (2000), issue 11, pages 36-38).

Japanese laid-open patent application JP 8098341 discloses a vacuum interrupter which is surrounded by a gel inside an insulating cylinder.

Furthermore, European patent application EP 0 354 494 A1 discloses a switchgear which has its interrupter units enclosed in a gel.

### SUMMARY OF THE INVENTION

The present invention discloses an electric switching device such that improved heat transfer through the insulating material is made possible.

The electric switching device of the type stated is accomplished by the insulating material having filling bodies.

The use of a gel makes it possible to remove the subassemblies enclosed by it, such as for example the interrupter unit, from the insulating material for servicing purposes and to use the insulating material again once servicing has been performed. The gel-like properties of the insulating material, brought about by a stronger bond of the molecules of the insulating material with one another than in the case of a liquid and at the same time a much weaker bond of the molecules than in the case of a solid material, allow such an insulating material to be repeatedly arranged around a subassemblies to be insulated. This makes it possible to dispense with destroying the known solid insulation. Filling bodies which are surrounded by the gel permit improved heat transfer from the interior of the electric switching device through the insulating material. At the same time, the advantageous properties of the gel mentioned above are retained. In comparison with the additionally known liquid or gaseous insulating materials, the use of a thixotropic gel in particular has advantages. In the case of liquid and gaseous insulating media, it is necessary to remove and temporarily store them before an interrupter unit is serviced. This is not necessary when a thixotropic gel is used. It need only be removed from the housing as and when required. On account of the soft structure, it is possible to pull out subassemblies from it without adversely influencing the mechanical properties of the thixotropic gel. When the subassembly is reintroduced, the thixotropic gel liquefies and comes to lie around the subassembly without any gaps. The gel subsequently solidifies.

Furthermore, it may be advantageously provided that the insulating material is a soft, vulcanized gel.

A soft, vulcanized gel comes to lie against walls virtually without any gaps or voids. This ensures that undesired voids are avoided in these regions. Such a vulcanisate also has a high inherent tack, which makes the insulating material adhere to surfaces without any additional structural devices.

An advantageous configuration further provides that the insulating material includes a silicone.

Silicones have favorable dielectric properties. In addition, such silicone gels are favorable for processing.

In an electric switching device, changing temperatures often occur. These temperature changes are caused both by external influences and by Joulean heat effects. It is necessary to compensate for changes in volume of the insulating material thereby occurring. If the insulating material itself is compressible, it is possible to dispense with the use of expansion volumes. As a result, a more compact and lower-cost type of construction of a switching device is possible.

Micro-voids enhance the compressibility of the insulating material. The size of these micro-voids is thereby chosen such that the resistance to partial discharges of the insulating material is not reduced. Such micro-voids may be created by foaming of the gel or advantageously also by the insulating material having filling bodies. Apart from the introduction of compressible filling bodies, such filling bodies may also be of an incompressible form. Polyethylene bodies are particularly suitable as filling bodies. These filling bodies increase the thermal conductivity of the insulating material and contribute to avoiding inadmissible heating of the electric switching device.

A further advantageous configuration provides that the housing is an insulating housing.

The use of customary insulating housings allows such switches to be integrated in already existing installations. If the use of electrically conducting material is envisaged for the housing, such an electric switching device can be integrated in a metal-enclosed, electric switchgear with little effort.

Furthermore, it may be advantageously provided that the interrupter unit is a vacuum interrupter.

Vacuum interrupters are suitable in particular for insulation with a thixotropic insulating material. An interrupter represents a hermetically sealed interrupter unit which can easily be enclosed in this insulating material.

In the case of a method for arranging an insulating material described above, it is also provided that the insulating material is introduced into the housing in a liquid state and the insulating material crosslinks to form a soft gel inside the housing.

The application of such a method produces time savings with regard to the production of such an insulated electric switching device, since an insulating material can be introduced relatively quickly into the housing in the liquid state. The crosslinking to form a soft gel can then take place inside the housing. More complex filling of the housings with crosslinked insulating material can be avoided in this way.

### BRIEF DESCRIPTION OF THE DRAWINGS

Exemplary embodiments of the invention are shown in the drawings, and described in more detail below.

In the drawings:

FIG. 1 shows a high-voltage circuit breaker with a vacuum interrupter and an insulating housing.

FIG. 2 shows a high-voltage circuit breaker with a vacuum interrupter and an electrically conducting housing.

### DETAILED DESCRIPTION OF THE INVENTION

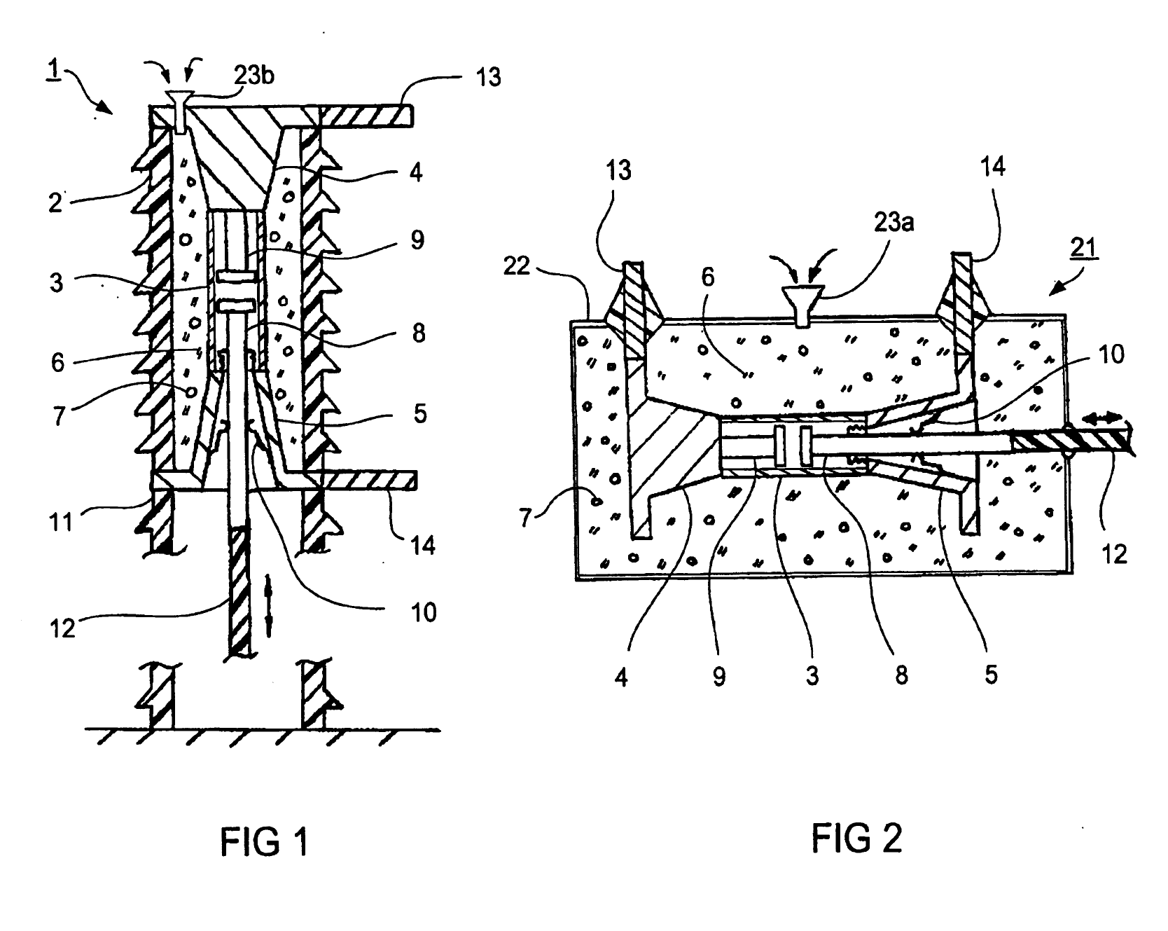

The high-voltage circuit breaker 1 represented in FIG. 1 has an insulating housing 2, in the interior of which an interrupter unit 3 is arranged. The interrupter unit 3, formed as a vacuum interrupter, is held in the interior of the insulating housing 2 by a first base 4 and a second base 5. The first base 4 and the second base 5 are produced from electrically conducting material. For connecting the high-voltage circuit breaker 1 into an electrical power supply system, a first connecting piece 13 is arranged on the first base 4 and a second connecting piece 14 is arranged on the second base 5. Apart from securement of the vacuum interrupter, the first base 4 and the second base 5 serve for the electrical contacting of a movable contact piece 8 and a stationary contact piece 9 of the vacuum interrupter. The stationary contact piece 9 is connected in an electrically conducting manner directly to the first base 4. The movable contact piece 8 is connected in an electrically conducting manner to the second base 5 via contact laminations 10. For driving the movable contact piece 8, an insulating drive rod 12 is coupled to the movable contact piece 9.

The high-voltage circuit breaker 1 is carried by a supporting insulator 11.

FIG. 2 shows a further high-voltage circuit breaker 21 with a metal housing 22. The structurally identical subassemblies of the configurational variants represented in FIGS. 1 and 2 are provided with the same reference numerals. The first and second connecting pieces 13, 14 are led through the metal housing 22 in an insulated and sealed manner. The insulating drive rod 12 is likewise led through the metal housing 22 in a sealed manner. By way of example, a filling opening 23a,b is arranged on the upper side of the metal housing 22 and of the insulating housing 2, respectively. By means of these filling openings 23a,b, an insulating material can be filled into the metal housing 22 and into the insulating housing 2.

The interior of the insulating housing 2 and of the metal housing 22 is filled with a silicone gel 6, acting as an insulating material. The outer dielectric strength of the vacuum interrupter 3 between the first base 4 and the second base 5 is ensured by the silicone gel 6. Furthermore, the dielectric strength with respect to the metal housing 22 is also ensured. The silicone gel 6 has a filler 7. This filler 7 may be elastically compressible or solid. The silicone gel 6 may be, for example, an addition-crosslinking two-pack silicone rubber. This silicone rubber does not vulcanize to form a silicone rubber in the conventional sense, but produces a soft vulcanisate. The silicone gel 6 has a very low hardness. A silicone gel 6 with an equivalent property is offered for example by the company Wacker-Chemie-GmbH under the designation Wacker Powersil®-Gel 79039. If a thixotropic gel is used, it liquefies under mechanical action and solidifies again in the state of rest. In this way, voids are avoided during assembly and also after servicing.

1. An electric switching device for medium or high voltage for the interruption of an electric current path by means of an interrupter unit (3), which is arranged inside a housing (2, 22) filled with a gel acting as an insulating material, characterized in that the insulating material has filling bodies.

2. The electric switching device as claimed in claim 1, characterized in that the filling bodies are incompressible.

3. The electric switching device as claimed in claim 1, characterized in that the filling bodies are compressible.

4. The electric switching device as claimed in one of claims 1 to 3, characterized in that the insulating material (6) is a vulcanized gel.

5. The electric switching device as claimed in one of claims 1 to 4, characterized in that the insulating material (6) contains a silicone.

6. The electric switching device as claimed in one of claims 1 to 5, characterized in that the housing (2) is an insulating housing.

7. The electric switching device as claimed in one of claims 1 to 6, characterized in that the housing (22) consists of electrically conducting material.

8. The electric switching device as claimed in one of claims 1 to 7, characterized in that the interrupter unit (3) is a vacuum interrupter.

9. A method for arranging an insulating material (6) as claimed in one of the preceding claims around an interrupter unit (3) inside a housing (2, 22) of an electric switching device, characterized in that the insulating material (6) is introduced into the housing in a liquid state and the insulating material (6) crosslinks to form a soft gel inside the housing (2, 22).
